(19) United States
(12) Patent Application Publication
(10) Pub. No.: US 2016/0207506 A1
(43) Pub. Date: Jul. 21, 2016

(54) Parked Vehicle Stabilizer Assembly

(71) Applicant: Gary Slager, Prophetstown, IL (US)

(72) Inventor: Gary Slager, Prophetstown, IL (US)

(21) Appl. No.: 14/869,516

(22) Filed: Sep. 29, 2015

Related U.S. Application Data
(60) Provisional application No. 62/104,105, filed on Jan. 16, 2015.

(51) Int. Cl. B60T 3/00

(52) U.S. Cl. CPC B60T 3/00

(57) ABSTRACT

A parked vehicle stabilizer assembly is provided that comprises a pair of stabilizer arms and an adjustable strap therebetween. The stabilizer arms comprise an adjustable length, an upper end, and a lower end. Each stabilizer arm has a telescoping structure to adjust the length thereof, whereby the upper end bears against the vehicle frame and the lower end bears against a ground surface. An adjustable strap is connected between the stabilizer arms using a first and second hook, whereby the strap is adjusted to place tension between the arms. The tension ensures the arms bear against the trailer and the ground as the weight of the trailer bears on the arms. This prevents rolling and pitching movement of the vehicle.

### CROSS REFERENCE TO RELATED APPLICATION

This application claims the benefit of U.S. Provisional Application No. 62/104,105 filed on Jan. 16, 2015. The above identified patent application is herein incorporated by reference in its entirety to provide continuity of disclosure.

### BACKGROUND OF THE INVENTION

### Field of the Invention

The present invention relates to vehicle supports and trailer stabilizers. More specifically, the present invention pertains to a stabilizer assembly and kit that prevents trailer roll when parked and when installed thereunder.

Recreational vehicles and campers are generally parked in one location for periods of time, particularly during a trip when a destination is reached and overnight stay is desired. During windy periods, these vehicles tend to sway while parked. The large surface area along the sides of the vehicle, combined with the suspension, differences in air pressure cause movement of the vehicle cabin. Swaying can also be created by users in the vehicle, who may be moving from one area of the vehicle to another while the vehicle is parked.

While this is not always dangerous, it can be in high winds. It can also be bothersome to those in the vehicle trying to rest or sleep. A need therefore exists to prevent this unwanted motion and to stabilize the vehicle. While more active suspension systems may correct for such movement, what is needed is a passive system that is simple, readily deployable, and low cost. The present invention provides a stabilizer assembly that can be deployed on most trailers and recreational vehicles, whereby a pair of stabilizer arms abuts against the vehicle frame and braces the frame against the ground surface. Tension is maintained between the stabilizer arms and the frame using an adjustable strap between the arms, while the arms bear into the ground and resist side-to-side rolling and rearward pitching of the vehicle.

### SUMMARY OF THE INVENTION

The following summary is intended solely for the benefit of the reader and is not intended to be limiting in any way. The present invention provides a new parked vehicle stabilizer assembly wherein the same can be utilized for providing convenience for the user when stabilizing a parked vehicle to prevent rolling or pitching motion.

It is therefore an object of the present invention to provide a new and improved parked vehicle stabilizer assembly that has all of the advantages of the prior art and none of the disadvantages.

It is another object of the present invention to provide a parked vehicle stabilizer assembly that stabilizes a parked vehicle and braces the vehicle to prevent rolling and pitching movement while parked.

Another object of the present invention is to provide a parked vehicle stabilizer assembly that comprises a first stabilizer arm and a second stabilizer arm having an adjustable length, an upper end, and a lower end. The first stabilizer arm and the second stabilizer arm each have an upper arm portion and a lower arm portion in a telescoping relationship to adjust the length thereof. The upper end of each arm is placed against the underside of a vehicle frame, while the lower end of each arm is placed against a ground surface.

Another object of the present invention is to provide a parked vehicle stabilizer assembly, whereby each arm further comprises a hook attachment extending from an interior side thereof. The hook attachments are used to secure an adjustable strap having a length, a length adjuster therealong, a first end, and a second end. The strap tensions the arms together, ensuring the upper ends abut against the vehicle frame, and the lower ends bear against a ground surface.

Another object of the present invention is to provide a parked vehicle stabilizer assembly, whereby the arms further comprise a V-shaped trailer support pad along the upper ends thereof, and a ground support pad along the lower ends thereof.

Another object of the present invention is to provide a parked vehicle stabilizer assembly, whereby the first end of the adjustable strap comprising a strap hook adapted to be received by the first hook attachment of the first stabilizer arm, and the second end of the adjustable strap comprising a strap hook adapted to be received by the second hook attachment of the second stabilizer arm. The strap secures between the arms and tensions them together.

Another object of the present invention is to provide a parked vehicle stabilizer assembly whereby the V-shaped trailer support pad of each arm is adapted to nest against a portion of a trailer frame and bear thereagainst, and whereby the ground support pad of each arm is adapted to bear against a ground surface below the trailer frame.

Another object of the present invention is to provide a parked vehicle stabilizer assembly whereby the adjustable strap is adapted to affix to the first hook attachment and the second hook attachment, and draw the first stabilizer arm toward the second stabilizer arm and prevent rolling motion of the trailer frame while in a working state and when the vehicle is parked.

Another object of the present invention is to provide a parked vehicle stabilizer assembly wherein the ground support pad of the first stabilizer arm further comprises an L-shaped pad having an upright portion aligned with the length of the first stabilizer arm and a base portion aligned with the lower end of the first stabilizer arm.

Another object of the present invention is to provide a parked vehicle stabilizer assembly wherein the ground support pad of the second stabilizer arm further comprises an L-shaped pad having an upright portion aligned with the length of the second stabilizer arm and a base portion aligned with the lower end of the second stabilizer arm.

Another object of the present invention is to provide a parked vehicle stabilizer assembly whereby the adjustable strap further comprises a ratchet strap comprising a ratchet assembly, a first strap length, and a second strap length. The ratchet assembly is adapted to spool a portion of the second strap length to adjust the length of the adjustable strap.

Finally, another object of the present invention is to provide a parked vehicle stabilizer assembly whereby the first hook attachment is disposed along the upper arm portion of the first arm portion, and the second hook attachment is disposed along the upper arm portion of the second arm portion.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows the trailer stabilizer assembly of the present invention in a stowed state.

FIG. 2 shows the trailer stabilizer assembly in a working state below a vehicle chassis.

FIG. 3 shows another view of the trailer stabilizer assembly of the present invention in a working state.

FIG. 4 shows a view one stabilizer arm of the trailer stabilizer assembly, whereby the telescoping construction is visualized.

FIG. 5 shows the upper end of one stabilizer arm in connection with the frame of a vehicle.

FIG. 6 shows a view of a trailer from the rear, whereby the trailer stabilizer assembly of the present invention is deployed to prevent rolling and rearward pitching motion.

### DETAILED DESCRIPTION OF THE INVENTION

Reference is made herein to the attached drawings. Like reference numerals are used throughout the drawings to depict like or similar elements of the trailer stabilizer assembly of the present invention. For the purposes of presenting a brief and clear description of the present invention, the preferred embodiment will be discussed as used for stabilizing a vehicle using stabilizer arms tensioned together and bracing the vehicle frame to the ground to prevent rolling or rearward pitching of the vehicle. The figures are intended for representative purposes only and should not be considered to be limiting in any respect.

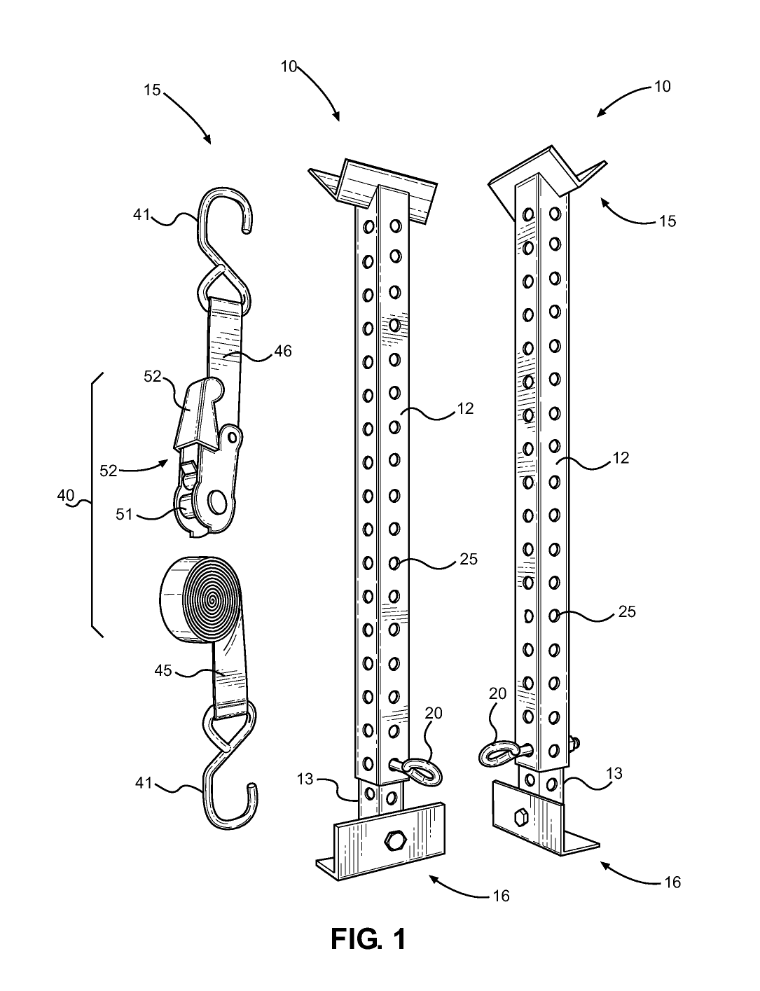

Referring now to FIG. 1, there is shown a view of the trailer stabilizer assembly of the present invention in a stowed state, whereby the individual elements of the assembly are separated. The assembly comprises a first and second stabilizer arm 10 that are used to stabilize a parked vehicle by bracing the frame of the vehicle against the ground to prevent rolling, rocking, or pitching of the vehicle. Each of the stabilizer arms 10 comprises an adjustable length, an upper end 15, and a lower end 16. The length of the arms 10 is such that the upper end 15 is adapted to bear against the vehicle frame, while the lower end 16 of the arm is adapted to bear against the ground when the arm is at an angle extending downward and outward from the vehicle. In this way, the vehicle frame bears against the arms 10 when the arms are supported against the frame of the vehicle and against the ground, whereby the arms 10 counteract motion of the vehicle in high winds or other inputs.

The stabilizer assembly of the present invention further comprises an adjustable strap 40 having a length, a length adjuster 50 therealong, and a pair of ends 41. The adjustable strap 40 comprises a strap with a length adjuster 50 therealong to adjust the length of the strap, whereby the strap 40 is adapted to be placed between the two stabilizer arms 10 when the arms 10 are in a working position. The strap 40 is tensioned therebetween to draw the arms 10 together. The ends 15, 16 of the arm are drawn, thereby drawing the upper end 15 against the vehicle frame and drawing the lower end 16 toward the ground surface. The tension on the strap 40 ensures the arms 10 remain statically disposed, whereby the lower ends 16 of the arms bear into the ground and the upper ends 15 firmly support the vehicle frame to prevent motion thereof.

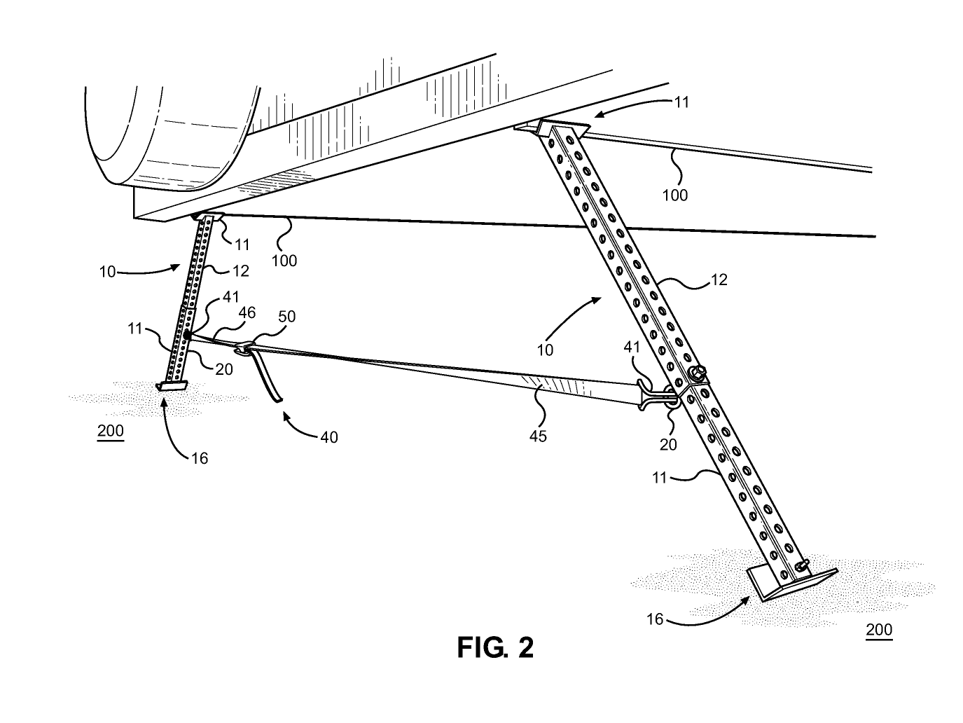

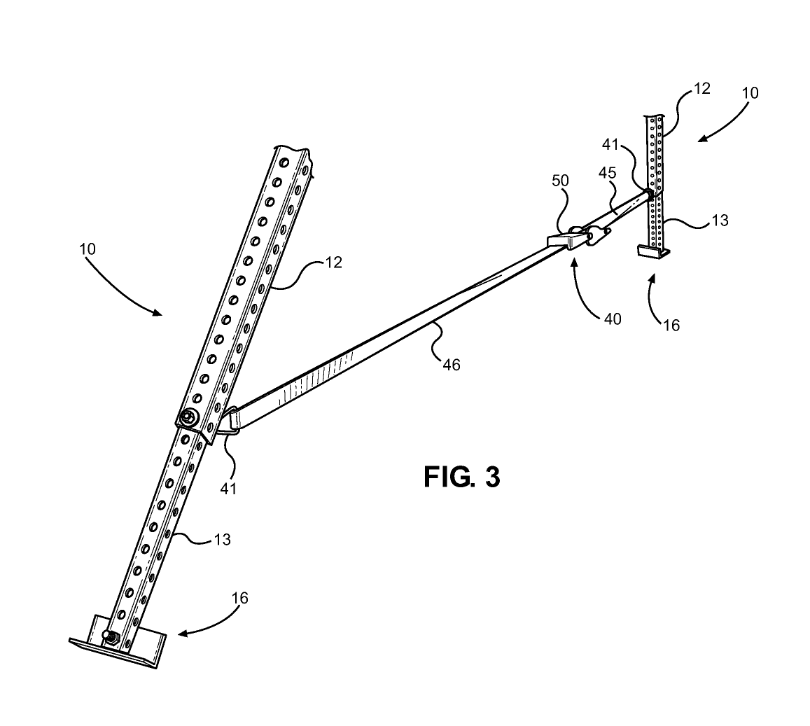

Referring to FIGS. 1-3, the connection between the strap 40 and the arms 10 is visualized. The strap 40 comprises a first end and a second end, whereby each end has a strap hook 41 affixed thereto. The strap hooks 41 are used to secure to a first and second hook attachment 20 extending from an interior side of the stabilizer arm 10. The hook attachments 20 are substantially enclosed hardware hooks or equivalent hook members that are used to secure the strap hooks 41, and thus the strap 40, between the arms 10. The strap hooks 41 engage the hook attachments 20 of the arms after the arms have been placed into a working position against the vehicle frame 100 and the ground surface 200. The strap 40 is then adjusted using the strap adjuster 50, whereby the free length of strap between strap hooks 41 is reduced until the strap is tensioned and a load is imparted on the arms 10. The load draws the arms 10 together, thereby securing the arms in the working position against the vehicle frame 100 and the ground surface. Then tension on the strap 40 is controlled by the user, whereby the user tensions the strap such that the arms are sufficiently stable against the vehicle and the ground.

To ensure the arms 10 have a length sufficient to extend from the vehicle frame 100 to the ground at the outward angle, the length thereof is adjustable. The arms 10 comprise an upper arm portion 12 and a lower arm portion 11 in a telescoping relationship to one another to adjust the overall length of each arm. The upper arm portion 12 and the lower arm portion 11 are slidable relative to one another, whereby one portion receives the other portion within its interior to form a prismatic joint or sliding joint. The two portions are then secured in a static relationship, whereby the length of each arm is fixed after the two portions are secured together.

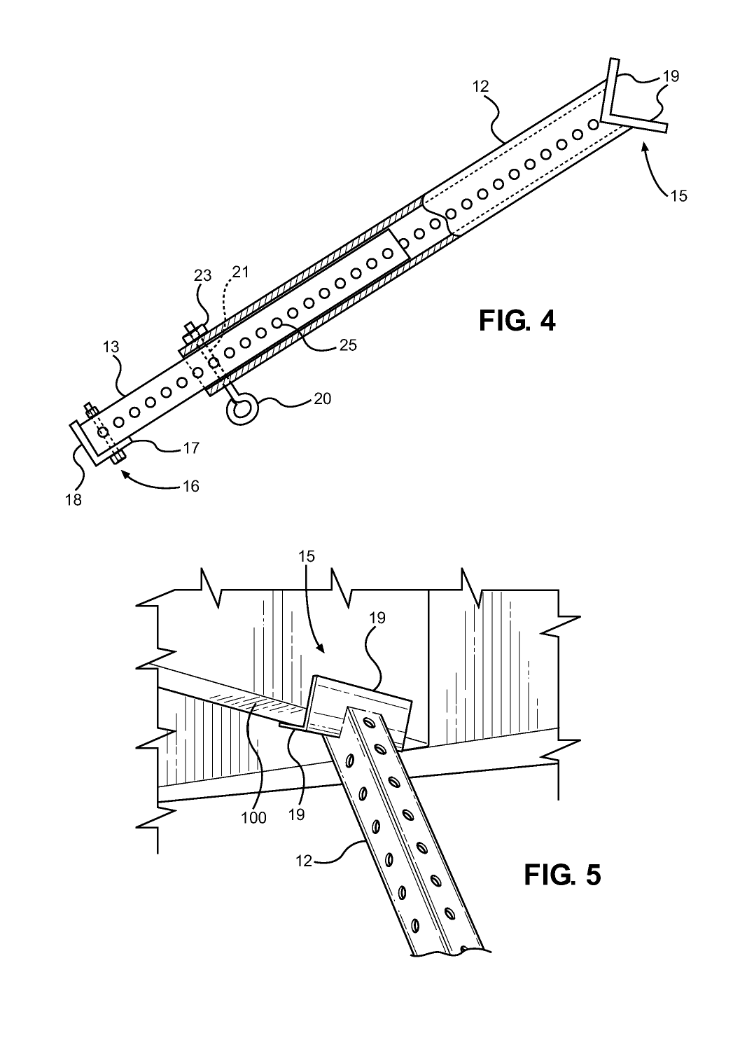

In one embodiment, the two portions 11, 12 are secured together using a fastener that extends through a pair of aligned apertures 25 between the two portions. In particular, the upper arm portion 12 includes a first plurality of aligned apertures such that a fastener can be extended through the body of the upper portion 12. Similarly, the lower arm portion 11 comprises a second plurality of aligned apertures such that a fastener can be extended through the body of the lower portion 11. The first and second plurality of aligned apertures are then aligned such that a fastener can be extended through the two sets of apertures and thus through the aligned upper and lower arm portions. This arrangement is shown in FIG. 4, whereby the fastener 21 is a shank portion of the hook attachment 20. The shank portion of the fastener 21 extends through the aligned aperture sets 25 of the upper 12 and lower 11 arm portions. A securing nut 23 is used to secure the fastener shank along an opposite side of the hook attachment 20, which is removably secured and prevents pull-through of the fastener. This arrangement is one embodiment, whereby the arm portion securing fastener 21 and the hook attachment 20 are one in the same. Alternate configurations are contemplated, whereby a separate hook attachment 20 and fastener 21 are provided.

Each of the stabilizer arms 10 comprises an upper end 15 and a lower end 16. The upper end 15 bears against a vehicle frame, while the lower end bears against a ground surface 16. In one embodiment, the upper end 15 of each arm 10 comprises a trailer support pad. The support pad may be a planar member at an angle relative to the arm 10, and it may be statically disposed relative thereto or pivotably affixed. In another embodiment, the trailer support pad may comprise a V-shaped member, whereby the V-shaped member comprises a first and second surface 19, as shown in FIG. 4. The surfaces 19 form a V-shaped support pad with an interior angle separating the two surfaces 19. A portion of the vehicle frame is adapted to be placed between the two surfaces 19, whereby the surfaces 19 bear against the frame and receive the frame within its interior angle. This allows a corner or exposed portion of the vehicle frame to be nested between the surfaces 19 of the V-shaped support pad.

Similarly, the lower ends 16 of the stabilizer arms each comprise a ground support pad. Like the upper ends, the lower end support pad may comprise a planar member at an angle relative to the arm 11, whereby the planar member may be statically disposed relative thereto or pivotably affixed thereto. In one embodiment of the ground support pad, and as shown in FIG. 4, the pad comprises an L-shaped pad having an upright portion 17 aligned with the length of the stabilizer arm 10, and a base portion 18 aligned with the lower end of the arm 10. The L-shaped pad forms a footer that can bear into a ground surface when the arm 10 is at an angle relative to the vehicle and tensioned towards the opposing arm by the strap. The L-shaped pad may be secured to the lower end 16 of the arm 10 by a fastener that extends through the arm and fastens the pad thereto.

Referring to FIG. 1, an embodiment of the strap adjuster 50 is shown. In this embodiment, the strap adjuster comprises a ratchet strap assembly. The strap adjust may comprises a ratchet strap assembly; however, the strap adjust may also comprises slidable clasp or similar adjuster assembly that draws two lengths of strap together to reduce the overall strap length. The strap 40 is comprised of a first strap length 45 and a second strap length 46, whereby the strap adjuster is adapted to draw the lengths together and effectively reduce the overall length of the strap between the end hooks 41. The first strap length 45 is placed through the strap adjustor, whereby a portion of the first strap length 45 extends between the adjuster and the hook of the first strap length. In doing so, a free length of the first strap length 45 is created, which can be secured appropriately. This is a common arrangement for length adjustable cargo straps and the like.

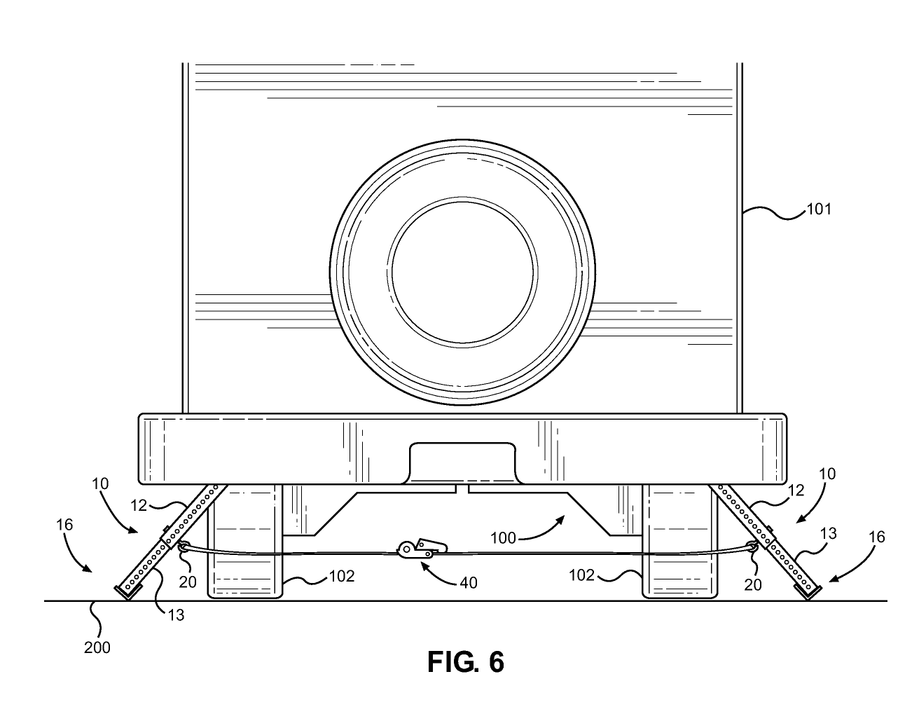

Using a ratchet strap adjuster, the first strap length 45 is positioned on a spool 51, and a ratchet mechanism and handle 52 are used to draw the first strap length 45 onto the spool 51. This reduces the free length of the first strap length 45 between the spool 51 and the hook 41 affixed to the first strap length 45. The second strap length 46 is a constant length, whereby the extent of the first strap length 45 on the spool 51 determines the overall strap length, and thus the tension placed on the arms when the strap is hooked therebetween. In a preferred embodiment, and as shown in FIG. 6, the hook attachment 41 of the first strap length 45 is disposed along the upper arm portion 12 of a first arm portion 10, and the hook attachment 41 of the second strap length 46 is disposed along the upper arm portion 12 of the opposing arm portion 10. The length of the strap 40 is adjusted using the adjuster, thereby drawing the arms 10 together as they bear against the vehicle frame and against the ground surface.

Overall, it is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A trailer stabilizer assembly for preventing side to side roll of a parked trailer, comprising:
a first stabilizer arm having an adjustable length, an upper end, and a lower end;
a second stabilizer arm having an adjustable length, an upper end, and a lower end;
the first stabilizer arm and the second stabilizer arm each having an upper arm portion and a lower arm portion in a telescoping relationship to adjust the length thereof;
the upper ends of the first stabilizer arm and the second stabilizer arm comprising a V-shaped trailer support pad;
the lower ends of the first stabilizer arm and the second stabilizer arm comprising a ground support pad;
a first hook attachment extending from an interior side of the first stabilizer arm;
a second hook attachment extending from an interior side of the second stabilizer arm;
an adjustable strap having a length, a length adjuster therealong, a first end, and a second end;
the first end of the adjustable strap comprising a strap hook adapted to be received by the first hook attachment of the first stabilizer arm;
the second end of the adjustable strap comprising a strap hook adapted to be received by the second hook attachment of the second stabilizer arm;
whereby the V-shaped trailer support pad of each of the first stabilizer arm and the second stabilizer arm being adapted to nest against a portion of a trailer frame and bear thereagainst;
whereby the ground support pad of the first stabilizer arm and the second stabilizer arm are adapted to bear against a ground surface below the trailer frame; and
whereby the adjustable strap is adapted to affix to the first hook attachment and the second hook attachment, and draw the first stabilizer arm toward the second stabilizer arm and prevent rolling motion of the trailer frame while in a working state.

2) The trailer stabilizer assembly of claim 1, wherein:
the ground support pad of the first stabilizer arm further comprises an L-shaped pad having an upright portion aligned with the length of the first stabilizer arm and a base portion aligned with the lower end of the first stabilizer arm; and
wherein the ground support pad of the second stabilizer arm further comprises an L-shaped pad having an upright portion aligned with the length of the second stabilizer arm and a base portion aligned with the lower end of the second stabilizer arm.

3) The trailer stabilizer assembly of claim 1, wherein:
the adjustable strap further comprises a ratchet strap comprising a ratchet assembly, a first strap length, and a second strap length;
whereby the ratchet assembly is adapted to spool a portion of the second strap length to adjust the length of the adjustable strap.

4) The trailer stabilizer assembly of claim 1, wherein:
the first hook attachment is disposed along the upper arm portion of the first arm portion; and
the second hook attachment is disposed along the upper arm portion of the second arm portion.
